(19) United States
(12) Patent Application Publication
(10) Pub. No.: US 2011/0107126 A1
(43) Pub. Date: May 5, 2011

(54) System and method for minimizing power consumption for a workload in a data center

(76) Inventor: Alan L. Goodrum, Tomball, TX (US)

(21) Appl. No.: 12/588,856

(22) Filed: Oct. 30, 2009

(51) Int. Cl. G06F 1/32

(52) U.S. Cl. 713/320

(57) ABSTRACT

A system and method are disclosed for minimizing power consumption for a workload in a data center having two or more computers. The system and method execute a server-centric management tool that provides a workload-power cost function to predict a cost of running a workload on a server. The workload-power cost function is executed by the processor and includes as an input a unique designation of the server. The workload-power cost function includes as an output the cost of running the workload on the server. The system and method provide the output of the workload-power cost function to a workload placement tool to efficiently place the workload.

### BACKGROUND

As power becomes more and more a precious resource in the data center, there is an increasing demand for solutions that reduce power consumption. The amount of power a particular workload consumes depends not only on the type of workload, but also on the characteristics of the server on which it runs, and the environment of that server.

Migration of Virtual machines (VMs) and the placement of other portable workloads are generally decided today based on the location of available central processing unit (CPU), the storage, and the network capacity. Some tools, such as Hewlett Packard's Capacity Advisor, predict power consumption based on a static mapping of the CPU utilization to power, with no awareness of the characteristics of the workload or the present environmental state of the server.

### DESCRIPTION OF THE DRAWINGS

The detailed description will refer to the following drawings in which like numbers refer to like objects, and in which:

FIG. 1 illustrates an embodiment of a system for minimizing power consumption for a workload in a data center;

FIG. 2 illustrates exemplary inputs and outputs of the workload-power cost function of FIG. 1;

FIG. 3 is a flow chart illustrating an embodiment of a method for minimizing power consumption for a workload in a data center; and

FIG. 4 illustrates exemplary hardware components of a computer that may be used in connection with the method for minimizing power consumption for a workload in a data center.

### DETAILED DESCRIPTION

Embodiments of a method and system are disclosed for minimizing power consumption for a workload in a data center. The amount of power a particular workload consumes may depend upon several factors. One factor may be the type of workload. For example, floating point applications tend to consume more power than integer applications. Another factor may be the characteristics of the server on which the workload runs. For example, ProLiant G6 servers are considerably more energy efficient than ProLiant G5 servers. Furthermore, the baseline load of an individual server running no work at all varies from one server to another. Another factor may be the present state of the server. For example, a servers operating in a high ambient temperature environment may have a higher cost for an incremental workload than a server in a cooler environment, because fan power is generally a nonlinear function of ambient temperature. Further, the location of the server is also important. For example, the cost of cooling a server located in a data center where hundreds of other servers are running may be higher than cooling an isolated server.

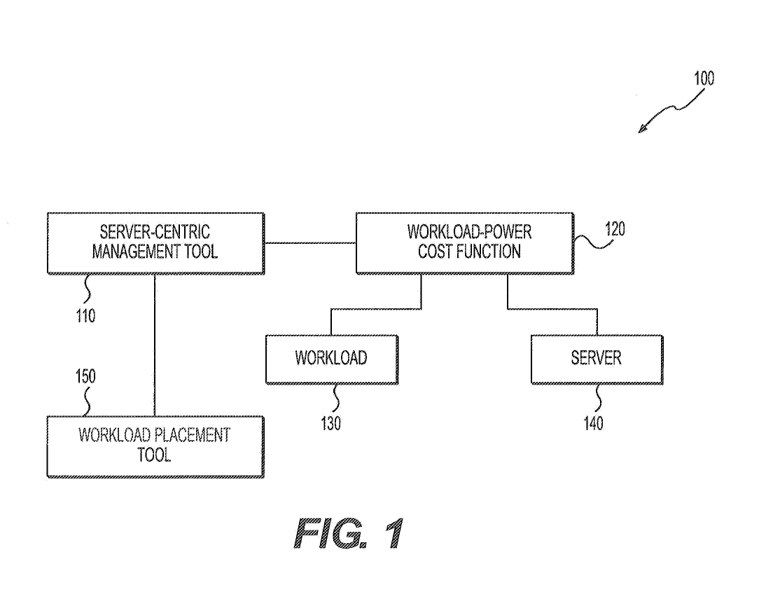

FIG. 1 illustrates an embodiment of a system 100 for minimizing power consumption for a workload in a data center for workloads. In an embodiment, a server-centric management tool 110 (i.e., server-centric management software) provides a workload-power cost function 120 to predict and indicate the amount of power a particular workload 130 would require if that workload were to be run on a particular server 140. An existing workload placement tool 150, such as a virtual machine (VM) scheduler or load balancer, may call the server-centric management tool 110 to determine the cost of running the workload 130 on a particular server 140. The workload 130 may be efficiently placed by the workload placement tool 150 to minimize power consumption.

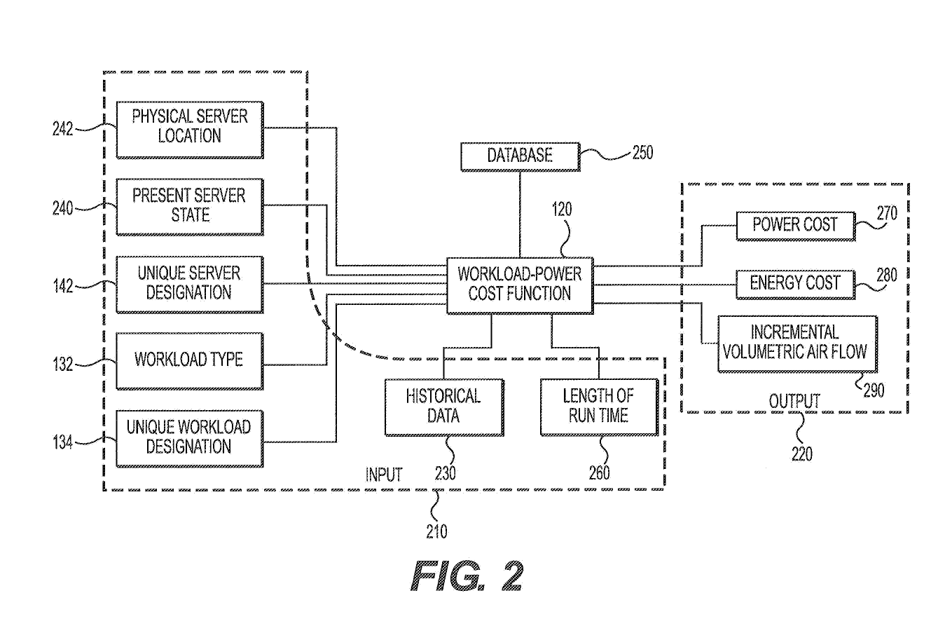

FIG. 2 illustrates exemplary inputs 210 and outputs 220 of an embodiment of the workload-power cost function 120. For example, the input 210 to the workload-power cost function 120 may be a unique designation 142 of the candidate server 140 or servers.

The input 210 to the workload-power cost function 120 may also include the present server state 240, e.g., the present ambient temperature of the candidate server 140, which makes the workload placement function “real time.” Alternatively, the present server state 240 may be retrieved automatically during execution of the workload-power cost function 120 from other centralized management databases 250 or from the candidate server 140 itself, based on the unique server designation 142 provided to the workload-power cost function 120.

The input 210 may also include the physical server location 242. For example, if the server 140 is located in a data center where hundreds of other servers are running, the cost of cooling that server 140 may be different than if the server 140 is isolated.

The input 210 may include a workload type 132 that characterizes the type of workload 130 in question. For example, the workload type 132 may include the amount of floating paint or other power-intensive operations included in the workload 130. Alternatively, a unique workload designation 134 may be provided so that historical data 230 of the workload execution may be evaluated to determine the power-consumption characteristics of the workload 130. For example, the workload-power cost function 120 may retrieve the information on the last execution of the workload 130 on a server 140. Such information may be stored in a database 250 residing either locally on the server 140 or remotely.

The input 210 to the workload-power cost function 120 may also include the length of time 260 the workload 130 is intended to run.

The output 220 from the workload-power cost function 120 may include the power cost 270 of running the workload 130 on the designated server 140. If the length of time is specified, the cost may be returned as energy cost 280 rather than power cost 270. The output 220 from the workload-power cost function 120 further may include the incremental volumetric airflow 290 that is required to cool the server 140 running the designated workload 130.

The server-centric management tool 110 may be operated and owned by a vendor of the server 140 because the server vendor, which may have built the hardware, may understand the power consumption characteristics of the server 140 the best.

The system and method for minimizing power consumption for a workload in a data center segregate the workload placement function (accomplished by the workload placement tool 150) from the power estimation function (accomplished by the server-centric management tool 110). VM management and load balancing companies have years of experience in workload placement without power information. Power consumption is highly dependent on the server 140, and server vendors understand the power information of the server 140 the best. Segregating the workload placement function and the power estimation function allows each company to optimize what it knows the best.

The system and method for minimizing power consumption for a workload in a data center do not need the publication of large volumes of power and thermal data about the server 140. The system and method may restrict the internal power and thermal data in its use, which simplifies the server vendors' life, and makes maintenance of the system 100 easier over time.

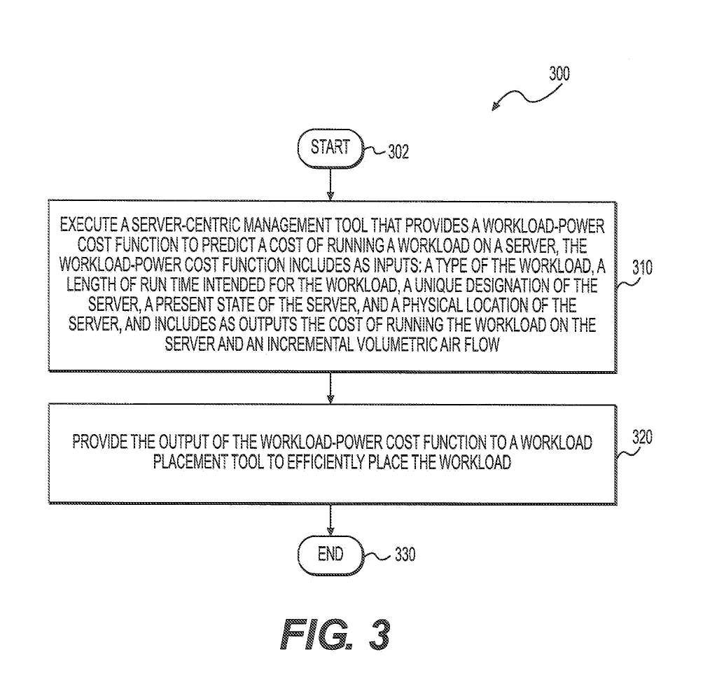

FIG. 3 is a flow chart illustrating an embodiment of a method 300 for minimizing power consumption for a workload in a data center. The method 300 starts 302 by executing a server-centric management tool 110 that provides a workload-power cost function 120 to predict a cost of running a workload 130 on a server 140 (block 310). The workload-power cost function 120 includes as inputs 210: a type of the workload 132, a length of run time 260 intended for the workload 130, a unique designation 142 of the server 140, a present state 240 of the server 140, and a physical location 242 of the server 140, and includes as outputs 220 the cost 270, 280 of running the workload 130 on the server 140 and an incremental volumetric air flow 290. The method 300 further includes providing the output 220 of the workload-power cost function 120 to a workload placement tool 150 to efficiently place the workload 130.

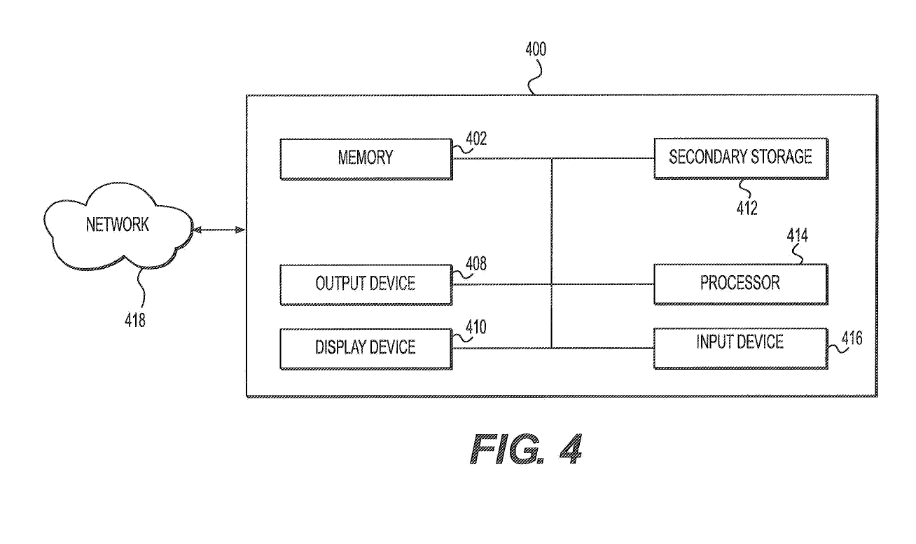

FIG. 4 illustrates exemplary hardware components of a computer 400 that may be used in connection with the method for minimizing power consumption for a workload in a data center. The computer 400 includes a connection with the network 418 such as the Internet or other type of computer or telephone network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, flash memory, or other types of non-volatile data storage, and may correspond with various databases or other resources. The processor 414 may execute instructions to perform the method steps described herein. For example, the processor 414 executes the server-centric management tool 110 to predict the cost 270, 280 of running a workload 130 on a particular server 140. These instructions may be stored in the memory 402, the secondary storage 412, or received from the Internet or other network. The input device 416 may include any device for entering data into the computer 400, such as a keyboard, keypad, cursor-control device, touch-screen (possibly with a stylus), or microphone. The display device 410 may include any type of device for presenting a visual image, such as, for example, a computer monitor, flat-screen display, or display panel. The output device 408 may include any type of device for presenting data in hard copy format, such as a printer, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the method for minimizing power consumption for a workload in a data center are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer 400 to perform a particular method.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for minimizing power consumption for a workload in a data center having two or more computers, the method being implemented by a computer including a processor and a memory, the method comprising:
executing a server-centric management tool that provides a workload-power cost function to predict a cost of running a workload on a server, wherein the workload-power cost function is executed by the processor and includes as an input a unique designation of the server, and wherein the workload-power cost function includes as an output the cost of running the workload on the server; and
providing the output of the workload-power cost function to a workload placement tool to efficiently place the workload.

2. The method of claim 1, wherein the output of the workload-power cost function includes an incremental volumetric air flow needed to cool the server running the workload.

3. The method of claim 1, wherein the input of the workload-power cost function includes a physical location of the server.

4. The method of claim 1, wherein the input of the workload-power cost function includes the present ambient temperature of the server.

5. The method of claim 1, wherein the unique server designation indicates a power efficiency of the server.

6. The method of claim 1, wherein the input of the workload-power cost function includes a description of the type of workload.

7. The method of claim 1, wherein a description of the type of workload is obtained from historical data stored in a database.

8. The method of claim 1, wherein the input of the workload-power cost function includes a length of run time intended for the workload.

9. The method of claim 1, wherein the workload-power cost function predicts a power cost of running the workload on the server.

10. The method of claim 1, wherein the workload-power cost function predicts an energy cost of running the workload on the server.

11. A system for minimizing power consumption for a workload in a data center having two or more computers, the system being implemented by a computer including a processor and a memory, the system comprising:
a server-centric management tool that provides a workload-power cost function to predict a cost of running a workload on a server, wherein the workload-power cost function is executed by the processor and includes as an input a unique designation of the server, and wherein the workload-power cost function includes as an output the cost of running the workload on the server; and
a workload placement tool that calls the workload-power cost function to obtain the output in order to efficiently place the workload.

12. The system of claim 11, wherein the output of the workload-power cost function includes an incremental volumetric air flow needed to cool the server running the workload.

13. The system of claim 11, wherein the input of the workload-power cost function includes a physical location of the server.

14. The system of claim 11, wherein the input of the workload-power cost function includes the present ambient temperature of the server.

15. The system of claim 11, wherein the input of the workload-power cost function includes a description of the type of workload.

16. The system of claim 11, wherein the workload-power cost function predicts a power cost of running the workload on the server.

17. The system of claim 11, wherein the workload-power cost function predicts an energy cost of running the workload on the server.

18. A computer readable medium providing instructions for minimizing power consumption for a workload in a data center having two or more computers, the instructions comprising:
executing a server-centric management tool that provides a workload-power cost function to predict a cost of running a workload on a server, wherein the workload-power cost function includes as an input a unique designation of the server, and wherein the workload-power cost function includes as an output the cost of running the workload on the server; and
providing the output of the workload-power cost function to a workload placement tool to efficiently place the workload.

19. The computer readable medium of claim 18, wherein the output of the workload-power cost function includes an incremental volumetric air flow needed to cool the server running the workload.

20. The computer readable medium of claim 18, wherein the input of the workload-power cost function includes a physical location of the server.
